(19) United States
(12) Patent Application Publication
(10) Pub. No.: US 2008/0301558 A1
(43) Pub. Date: Dec. 4, 2008

(54) Interface, Method, and System for Providing Inline Contextual Help and Support

(76) Inventors: Maryam Najafi, San Jose, CA (US); Len Osamu Toyoshiba, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/128,583

(22) Filed: May 28, 2008

Related U.S. Application Data
(60) Provisional application No. 60/940,679, filed on May 29, 2007.

(51) Int. Cl. G06F 3/01

(52) U.S. Cl. 715/708

(57) ABSTRACT

A method and apparatus is disclosed herein for providing contextually relevant support information. In one embodiment, a server provides a web page over a network that includes one or more help indicators. The web page and the help indicator are shown to a user in a window of a graphical user interface of the client device. When the user selects the help indicator, the support system receives data indicative of user help requests from the client device. In response to receipt of a support request, the support system generates a response based on a current context of the web page. In one embodiment the response is provided to the client device for display over an area in the window of the graphical user interface without obscuring or disrupting content displayed by the web page.

### PRIORITY

The present patent application claims priority to and incorporates by reference the corresponding provisional patent application Ser. No. 60/940,679, titled, “Interface, Method, and System for Providing Inline Contextual Help and Support” filed on May 29, 2007.

### FIELD OF THE INVENTION

The present invention relates to the field of graphical user interfaces; more particularly, the present invention relates to providing contextually relevant help information in a browser window without interrupting a user's current workflow.

### BACKGROUND OF THE INVENTION

Web and application help systems provide information in order to support users in completing their tasks. Current help systems rely heavily on methods that remove users from their train of thought and interrupt their task/work flow.

Existing help systems require that users enter or search for key words. This requires that the user remove himself from a current task and context, and transfer himself to a new task and concept. That is, the user must step away from their task to guess what terms, phases, concepts, etc. his answers are filed under. The results obtained may be wrong, or a user simply will not know what terms to supply to the help system.

Furthermore, existing help systems provide results in the form of user interface windows or pop-up windows. These windows are displayed over an existing window. The display over the existing window/display obscures and hides the next-stop action items that are vital to task completion within the obscured user interface.

Other help systems display support information within a frame as an application. However, such support systems are dedicated to a single application. Furthermore, the support information is provided in frames of a current application, thus displaying the help information over a portion of the application, or disrupting the user by causing the task window to be resized. In both instances the user's attention is diverted or distracted from the application at hand.

### SUMMARY OF THE INVENTION

A method and apparatus is disclosed herein for providing contextually relevant support information over a network. The method comprises providing a webpage over a network for display in a browser. The method further comprises receiving a help request and generating a contextually relevant support response. The method further comprises providing the response for display in the same browser window as the active web page without obscuring or disrupting the display of the content.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a network diagram of one embodiment of a network based support system.

FIG. 2 is a block diagram of one embodiment of a support request tool.

FIG. 3 is a block diagram of one embodiment of contextual support information response tool.

FIG. 4 is a flowchart of one embodiment for requesting and viewing help information.

FIG. 5 is a flowchart of one embodiment for generating a contextually relevant response to a support request.

FIG. 6A shows an exemplary representation of a user interface facilitating help information display.

FIG. 6B shows an exemplary representation of a user interface facilitating help information display.

FIG. 6C shows an exemplary representation of a user interface facilitating help information display.

FIG. 6D shows an exemplary representation of a user interface facilitating help information display.

FIG. 7A shows an exemplary representation of a user interface facilitating help information display.

FIG. 7B shows an exemplary representation of a user interface facilitating help information display.

FIG. 8 is a block diagram of one embodiment of a computer system which may be used with the present invention.

### DETAILED DESCRIPTION

A method and apparatus is disclosed herein for providing contextually relevant support information to a graphical user interface over a network. In one embodiment a system includes a communications network, a client device, and a support system coupled with the client device over the communications network. In one embodiment, the support system provides a web page over a network, which includes one or more help indicators, for display to a user in a window of a graphical user interface of the client device. The support system receives data indicative of a user help request. In response to receipt of a help request, the support system generates a response including information based on a current context of the web page. In one embodiment, the response is provided to the client device over the network for display over an area in the window of the graphical user interface without obscuring or disrupting the web page.

In one embodiment, a user browses a web page via a client device. The web page includes one or more help indicators, such as question mark icons, hyperlinks, shadowed text, etc. that are displayed on the web page.

In response to receiving data indicative of a help request (i.e., receiving user selection of a support indicator), a response is generated. In one embodiment, the response it based on a current context of the page when the request is received. The context is utilized to generate a response that includes support information appropriate to the request and the context from which the request was made.

The response is then provided over the network to the requester for display in a graphical user interface of the client device. In one embodiment, the response is displayed within the current browser window of the web page without obscuring or disrupting the user's work. Thus, a user receives contextually relevant support information, which is displayed so as not to divert the user's attention from the task at hand. Furthermore, because the request and support response are performed in response to the selection of a support indicator, such as a question mark icon, a user need not identify appropriate search terms, navigate through support topics, etc.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

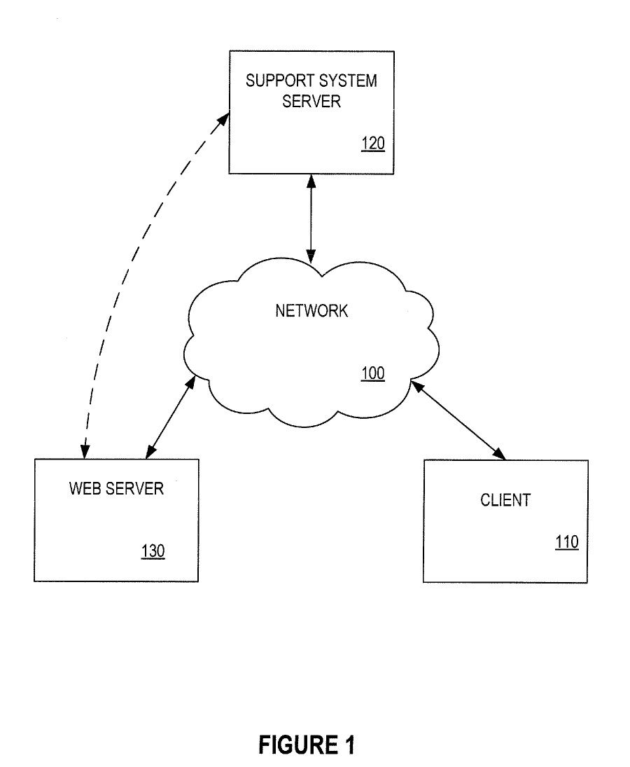

FIG. 1 is a network diagram of one embodiment of a network based support system, as described below. Client 110 is coupled to a web server 130 via network 100. For one embodiment, network 100 is an insecure network, such as the Internet. The client may be coupled to the network 100 via modem operating over telephony or cable lines, a digital subscriber line (DSL), a wireless connection, a local area network (LAN), or another type of connection.

Client 110 may be used to run a browser to view a web page, such as for example, a page permitting registration of a digital certificate with a certification authority. In one embodiment, a web page displayed by client 110, includes help indicators. Such help indicators are visually manifested within the web page in the form of a question mark icon, underlines, hyperlinks embedded within the web page, shadowed text, etc.

In one embodiment, a web page that includes support indicators, such as question mark icons, is served via network 100 from a support system web server 130 to client 110. In order for web server 130 to serve a web page including support indicators, in one embodiment, web server 130 requests support information from a support system server 120 over network 100. In another embodiment, web server 130 is coupled to support system server 120 via a wired or wireless connection (indicated by dashed line), and web server 130 requests the support information directly from support system server 120.

In one embodiment, help content is embedded in a web page that includes help indicators, and served along with the web page by web server 130. In one embodiment, the entire help content available for the provided support indicators is stored in and provided with the web page. In response to detecting activation of a help indicator, by client 110, in one embodiment, the help content embedded within the web page is invoked and provided upon activation of a help indicator. In one embodiment, the help content is part of a JavaScript™ application.

In another embodiment, when the user activates the help indicator, the support system server 120 is contacted by web server 130, and provides the appropriate help. In one embodiment, an application stored on the support system server 120 acquires the appropriate help content.

Appropriate help content is content that is contextually relevant to the task or web page, from which the activation of the help indicator was detected. That is, based on a specific task displayed in a web page, progress within the task, a specific selected help indicator, etc., support content that elaborates on, or provides guidance to, a certain task is automatically provided. In the embodiment where support information is obtained via instrumented logic within a web page, a help indicator may be linked to certain support topics within a support system server database (not shown), such as memory references, universal resource locators (URLs), support identification numbers, etc. Thus, detection of a specific support indicator triggers the acquisition of specific content via the reference/link.

In one embodiment, the acquisition of support information is dynamic. Selection of a help indicator may cause a keyword search to be performed on the text of a current task displayed in the browser window. The keyword search automatically acquires contextually relevant support information based on a natural language, Boolean, etc. search of the web page that triggered a support request. Furthermore, the dynamic acquisition of support information may be performed to supplement obtaining contextually relevant support information via references/links, and vise versa. In another embodiment, the support information for display may be coded into the web page itself. The dynamic acquisition of support information may, in the embodiments discussed above, be performed in response to a support request, or prior to serving a web page that includes support indicators.

Upon the client 110 receiving the contextually relevant support information via network 100, client 110 displays the support information within the same browser window. In one embodiment, client 110 receives the support information in a form that is browser neutral. Thus, the received support information ensures that whatever type of browser and/or client device receives the help information, it will be displayed properly.

In one embodiment, client 110 applies an animation effect to the support information when client 110 displays the support information. The animation effect may be a fade-in effect, slide effect, scroll effect, etc. As will be discussed below, when the support information is closed by client 110, client applies another animation effect to remove the support information display, such as a fade-out effect, slide effect, scroll effect, etc. In one embodiment, the animation effect is designed to be unobtrusive. In another embodiment, the animation effect is designed to immediately draw the user's attention.

Furthermore, a separate browser window, popup, etc. is not opened. As will be described in more detail below, the support information is displayed in a dedicated portion of the browser window. By not opening an additional browser, triggering a popup window, etc., a user's focus is not diverted from the task at hand. Rather, the user may obtain the desired help information while continually maintaining his or her train of thought and focus on the web page. In one embodiment, the cursor focus remains at the original location as well.

In one embodiment, the browser page may include areas within the web page that are not deemed essential, by varying degrees. In one embodiment, client 110 displays the support information over the non-necessary portion of a browser window, thereby not obscuring the useful portions of the webpage.

For example, the display of advertisements within a web page may be deemed not necessary for using the page. For example, when support information is requested and displayed during product registration, client 110 displays support information over the advertisements within the browser window. As such, the support information covers the non-essential content within the browser window. Alternatively, areas of a web page, such as work flow progress displays, blank spaces, etc. may have support information displayed over that area of the browser window.

In one embodiment, help content may include contextually relevant text, images, audio, animations, video, hypertext links, etc. or some combination of the preceding. Furthermore, help content in the form of hypertext may be provided to supply the user with an option to obtain additional support information and “drill down” to support information with more in-depth and detailed coverage of an issue.

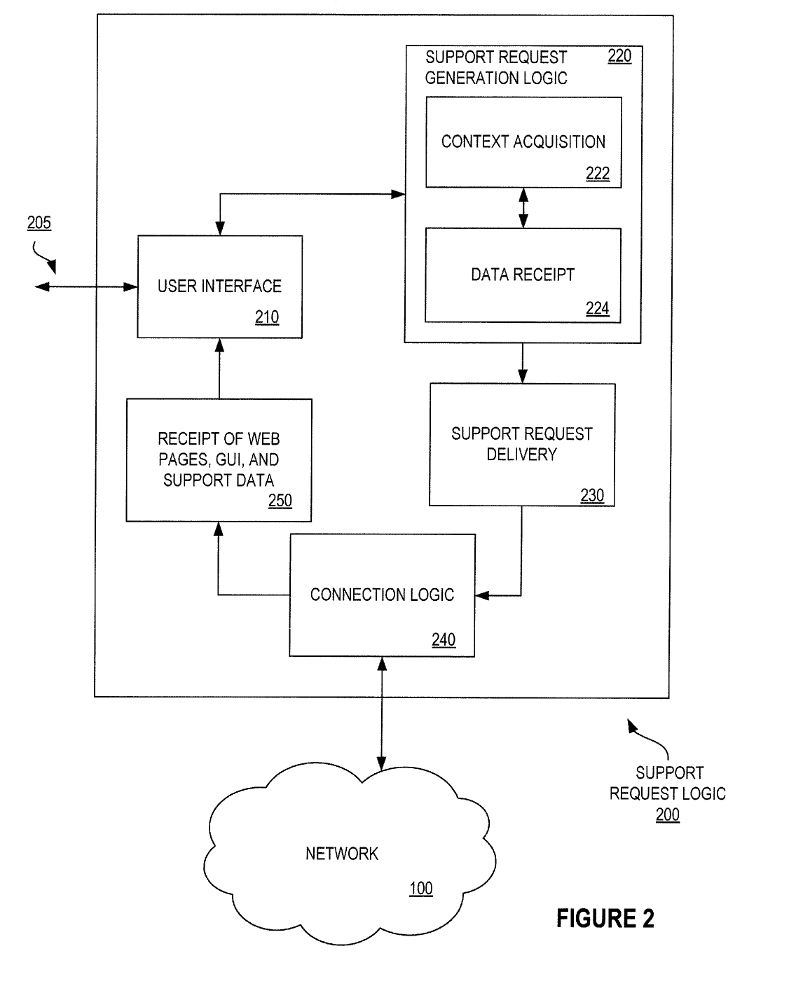

FIG. 2 is a block diagram of one embodiment of support request logic 200. In one embodiment, support request logic 200 is instrumented (e.g., embedded) into a web page, such as by JavaScript™. Support request logic receives a request for support information 205 via a user interface 210. User interface receives, for example, data indicating user selection of a help icon, help hypertext, etc.

The request is then transmitted to support request generation logic 220. In one embodiment, support request generation logic 220 composes the contextually relevant support request inquiry. In order for support request generation logic 220 to compose a support request inquiry, context acquisition logic 222 and data receipt logic 224 logic analyze the context of the request, and any data received along with the request.

In one embodiment, context acquisition logic 222 analyzes and gathers the selected support request indicator along with the current status of a corresponding web page, progress within an the page, references/links encoded in the selected indicator, etc. in order to generate a current context for a help request. Data receipt logic 224 further analyzes and gathers any data received from a user via the support request, such as data already entered into specific fields of a web page, or request for more detail regarding a current support request. The results of the analysis and gathering of context acquisition logic 222 and data receipt logic 224 are then combined by support request generation logic 220 into a request for support. In one embodiment, the request generated by support request generation logic 220 includes contextually relevant information regarding the web page, current status, current data, etc. and automatically composes a request based on that data. As such, a user does not need to enter context data, which would distract the user away from their current workflow, divert their attention from a current view of the web page, and maybe even remove user entirely from the task at hand.

The contextually relevant support request is then transmitted to support request delivery logic 230 for delivery to a support response logic via connection logic 240. As will be described in greater detail below, a support response logic receives the request and composes a response based on all of the relevant context data included in the support request.

Upon receiving a response to the request for support information, receipt of graphical user interface (GUI) and support data logic 250 configures the response for display on the browser page. In one embodiment, the configured response is browser agnostic—that is it displays properly regardless of the browser being used by the user. As discussed above, the response is provided to the browser page over an area that is not essential to the task or content currently being displayed. Thus, the contextually relevant support information is provided inline with a current task/page, in such a manner that it preserves the user's focus on their current task, while still allowing the user to view the requested support information. Furthermore, in one embodiment the web page display is not disturbed, resized, reformatted, etc.

In one embodiment, the response also includes an animation effect that is applied to the support information by GUI and support data logic 250, when the support information is displayed and removed from the display on the browser page. Exemplary animation effects include fade-in/fade-out, slide, scroll, etc. In one embodiment, the response also includes a topic based background color that is applied to the support information by GUI and support data logic 250. For example, support information related to work flow, technical issues, ordering questions, etc. are each displayed with different backgrounds to immediately notify a user of the type of support topic being displayed.

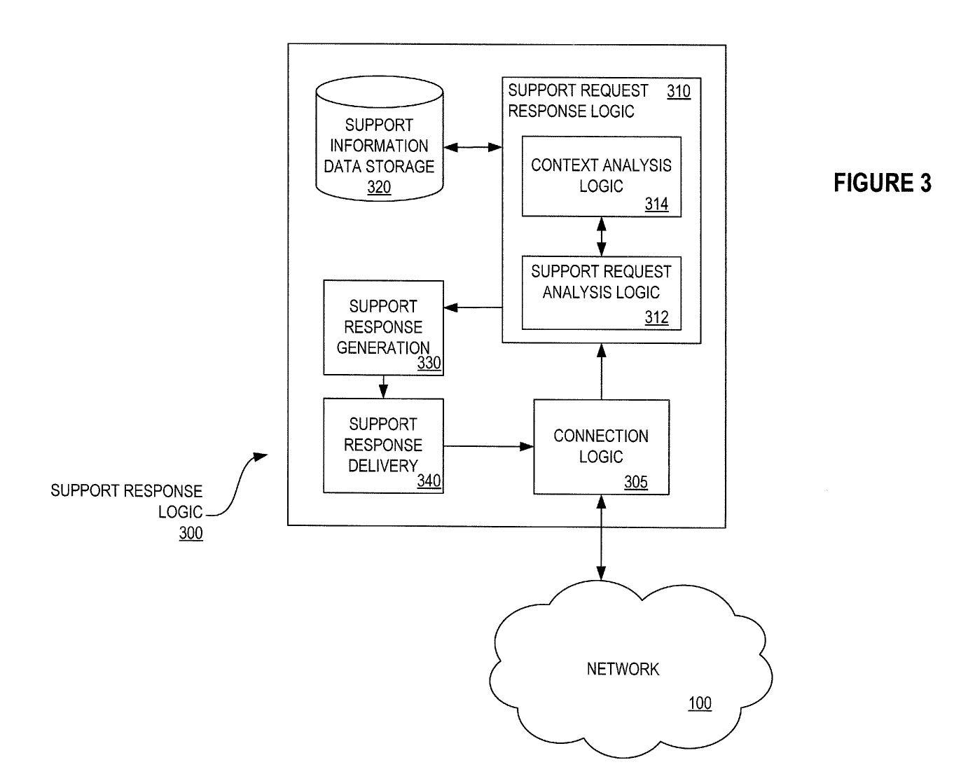

FIG. 3 is a block diagram of one embodiment of support response logic 300. Support response logic receives contextually based support requests via network 100 at connection logic 305. As discussed above, context relevant to a current task, progress level, current data entry, etc. are supplied to the support response logic 300 in the request.

In one embodiment, the request is forwarded to support request response logic 310. The request is analyzed by support request analysis logic 312 and context analysis logic 314 to determine relevant support information, to be supplied to the requester, based on the received contextual data. In one embodiment, a request indicator is provided with references to relevant support topics that are stored in support information data storage 320. Thus, based on the received request, support request response logic 310 may query support information data storage 320 for the support media referenced by the request. In one embodiment, context analysis logic 314 may search for support information (e.g., Boolean search, natural language search, etc.) based on text within the web page from which the support request originated. Thus, based on the logical queries of database 320, support request response logic 310 may search beyond the data referenced (e.g., a hyperlink, memory pointer, etc.) by a specific request reference. In one embodiment, a combination of references and contextual search are combined to obtain the content.

The query and retrieval results are then provided to support response generation logic 330. Support response generation logic 330 composes a response, based on the retrieved support information media, for display within the dedicated display area of the requesting browser page. In one embodiment, support response generation logic 330 includes an animation effect in the composed response. In one embodiment, support response generation logic 330 composes the background color, texture, etc. of the response display to provide different appearances for different types of support responses. For example, support responses directed to product ordering may be shown with blue backgrounds, while support responses directed to technical support issues may be shown with yellow backgrounds.

Support response delivery logic 340 then forwards the composed response to connection logic 305 for delivery to the requestor.

The generation of relevant support queries, and display of the results is removed from the control of the user. Therefore, the user is not removed from the task they are currently performing to, for example, enter search terms, browse a topic index, etc. Rather, the user may remain focused on a task at hand, while still receiving highly relevant support information. Furthermore, because the support system, as described here, is configured to display support information over non-essential and/or dedicated areas of a browser page, tasks are neither obscured nor altered by the received support information.

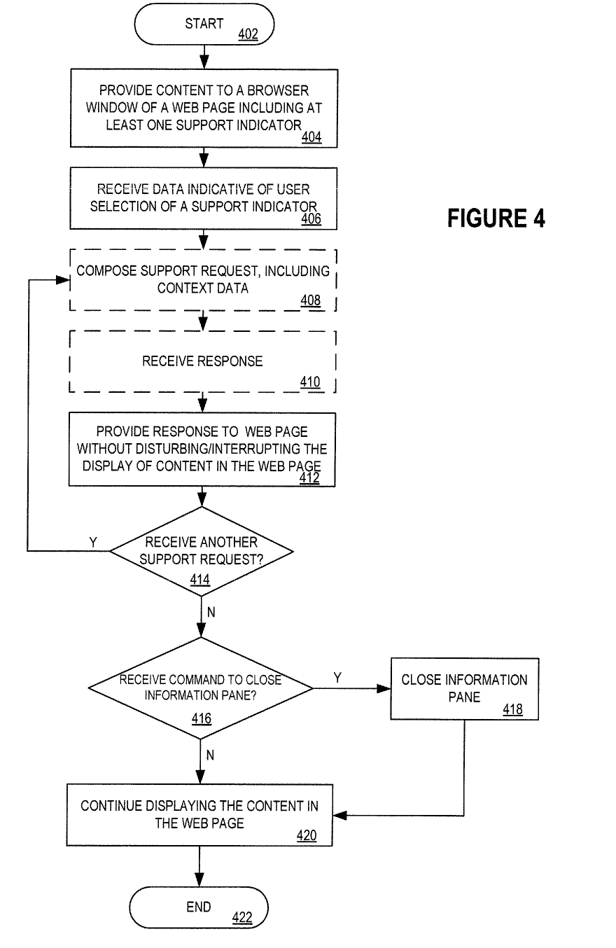

In one embodiment, the support request information and appropriate response are generated by a support server prior to a web page being served. As such, instead of the request and response paradigm discussed above, the support information would be generated by the support response logic of FIG. 3 based on support indicators that are embedded within a web site. Then, in response to user activation of a particular support indicator, the support request logic of FIG. 4, would display the received support content as discussed herein.

FIG. 4 is a flow diagram illustrating one embodiment of a method for providing contextual support in a browser window of a graphical user interface (GUI). The process is performed by processing logic that may comprise hardware (circuitry, dedicated logic, etc.), software (such as is run on a general purpose computer system or a dedicated machine), or a combination of both. The process starts at block 402 when a client accesses a web page served by a support system server.

Processing logic provides content to a browser window including at least one help indicator (processing block 404). In one embodiment, the help indicators may include one or more icons, hyperlinks, shadowed text, etc., or some combination of indicators. Upon receiving data indicative of a user selection of a support indicator (processing block 406), processing logic composes a support request, including context data (processing block 408). As discussed above the support request includes data that is contextually relevant to the browser page being displayed, the task being performed in the browser page, data currently supplied in a web page, etc. Furthermore, the support request includes the selected support indicator, which provides contextual information as to the specific element of the request.

Processing logic then receives a contextually relevant response to the support request (processing block 410). In one embodiment, as discussed above, support information is embedded in, and served with, a web page, and displayed upon user activation of a support indicator. Processing blocks 408 and 410 are displayed with dashed lines to indicate that in embodiments discussed herein, user activation of a support indicator triggers the display, via request and response, of support information that has been received along with the content of processing block 404.

The response is provided to a dedicated area, of a browser page without disturbing or interrupting the display of the content (processing block 412). In one embodiment, the response is provided over an area that may have content but is not essential to the completion of a current task, such as an area that displays advertisements, an area that displays progress of a task, an area that displays logos, etc. Because processing logic is configured to display the support information in the predetermined, dedicated, and non-essential area of a browser window, processing logic receives and provides a user with support information, without distracting or disrupting the user or her workflow. Furthermore, in one embodiment processing logic applies an animation effect, such as a fade in/out, slide, scroll, etc. effect, when displaying support content.

Processing logic then determines whether another support request has been received (processing block 414). If another request is received, the process returns to processing block 408 so that another support request may be composed (processing block 408). In one embodiment, because this is another request, the resulting support request provides additional, and more in-depth support information than that already received. In one embodiment, an additional support request activates additional support information that has been provided with content of a web page.

However, if another support request is not received processing logic then determines whether a command to close the support information pane has been received (processing block 416). If such a command is received, processing logic closes the help pane (processing block 418). Because the support information is displayed over a dedicated area of a browser window, the support information is “closed” by removing the support information from the page. In one embodiment, this may reveal previously covered content below. In one embodiment, the command to close the support information pane may be automatically generated if the user has continued the workflow beyond the area where the displayed help content is relevant. The command may also be generated in response to detecting selection of the original support indicator, a close icon, a close button, etc. This may be indicated, for example, by the user scrolling past the relevant area, or moving to another portion of the workflow. In one embodiment, support information is automatically removed when it is no longer relevant. In one embodiment, this may occur when the user moves off the field the support information is related to, for example by moving on to the next field of the form. In one embodiment, this may occur when the user scrolls past the area to which the support information is related. Other indications that the support information is no longer relevant may be detected as well, and used to trigger removal of the support information from the web page.

If a command to close the help pane is not received, the support information continues to be displayed in the browser window (processing block 420). The process ends when processing logic either navigates away from a browser window or the browser window and associated application are closed (processing block 422).

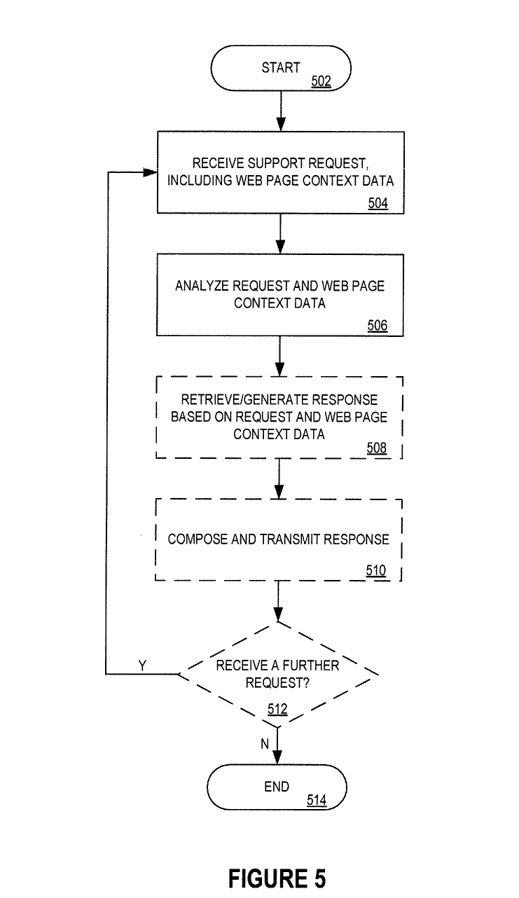

FIG. 5 is a flowchart of one embodiment of a process for responding to a support request. The process is performed by processing logic that may comprise hardware (circuitry, dedicated logic, etc.), software (such as is run on a general purpose computer system or a dedicated machine), or a combination of both. The process starts at block 502 when processing logic receives data. In one embodiment, the data is a support request including context data (processing block 504).

Because context data is included within the support request, processing logic analyzes the request including the context (processing block 506). The context may indicate the specific type of request, content displayed in a web page when the request was generated, etc.

Processing logic then retrieves and/or generates a response based on the request and context (processing lock 508). In one embodiment, request may include references to help topics or specific help content, such as text, images, sound, video, etc. However, responses may be based on a contextual database, as discussed above.

After processing logic obtains the contextually relevant support information, processing logic composes the support information into a response and transmits the response to the requester (processing block 510). As described above, the response is composed and configured so that it can be displayed in a dedicated predetermined area of a browser window, so as to minimize user distraction when the support information is displayed. Furthermore, the response may be composed with an animation effect applied to the support information when the information is displayed.

In one embodiment, as described above, support information may be embedded within a web page and served to a user without connecting to the server, directly from the embedded information. As such, processing blocks 508-512 are displayed with dashed lines to indicate that the processing to obtain contextually relevant support information may occur prior to service of a web page. In the embodiment, the support information and more detailed support information is obtained prior to the service of the web page, so that a web server may include the support information within a web page.

Processing logic then determines whether a further request for support information is received (processing block 512). If no further requests are received the process ends (processing block 514), otherwise processing logic returns to processing block 504 to receive the further support information request (processing block 504).

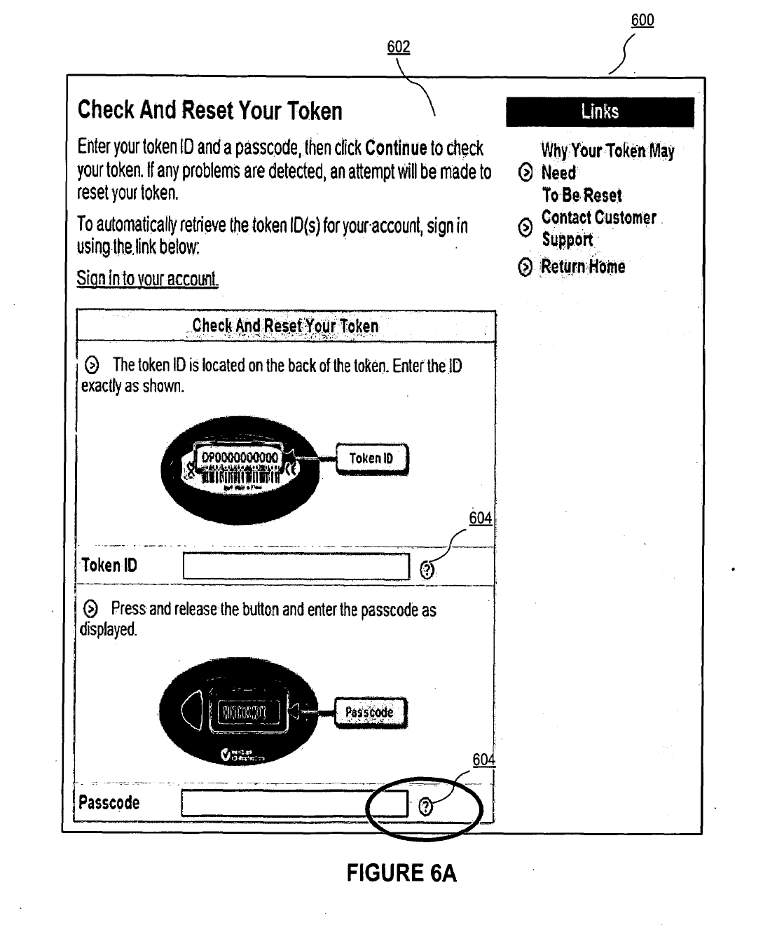

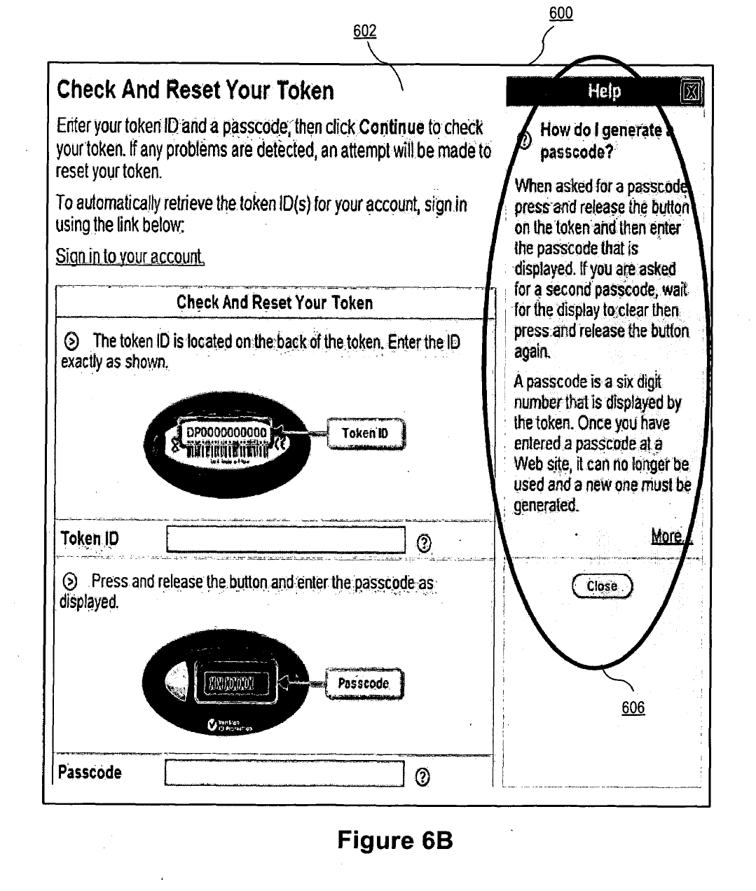

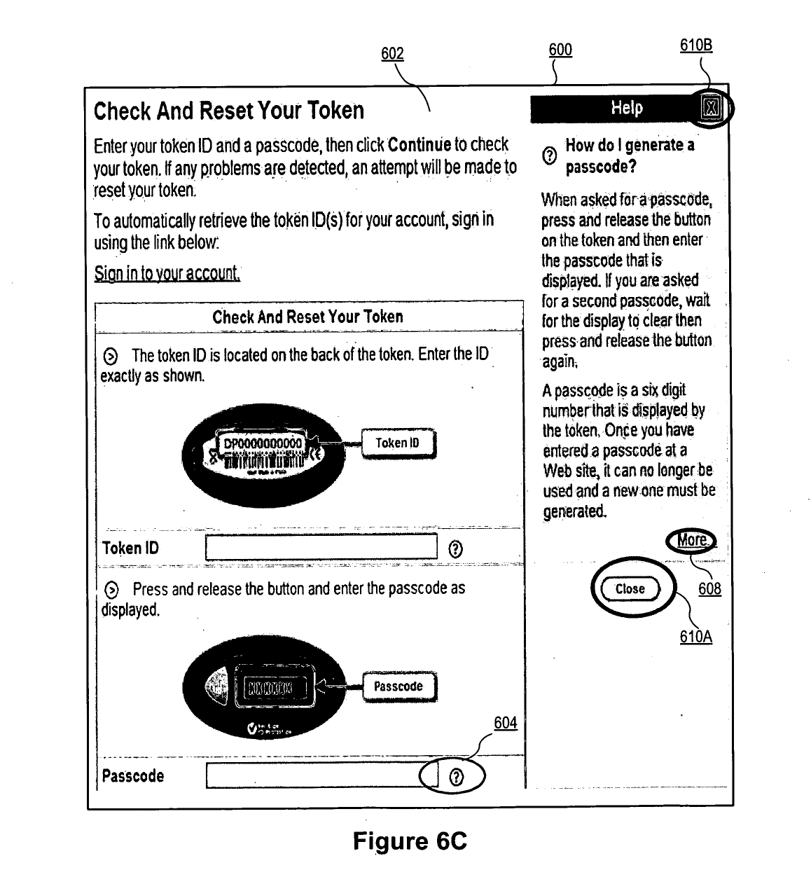

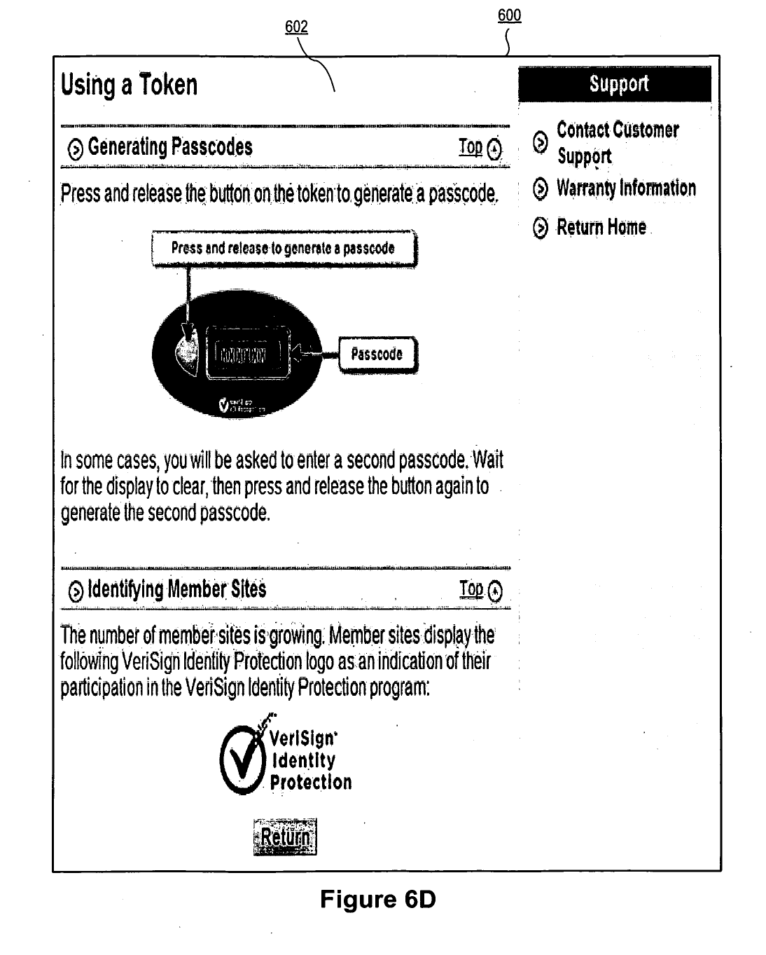

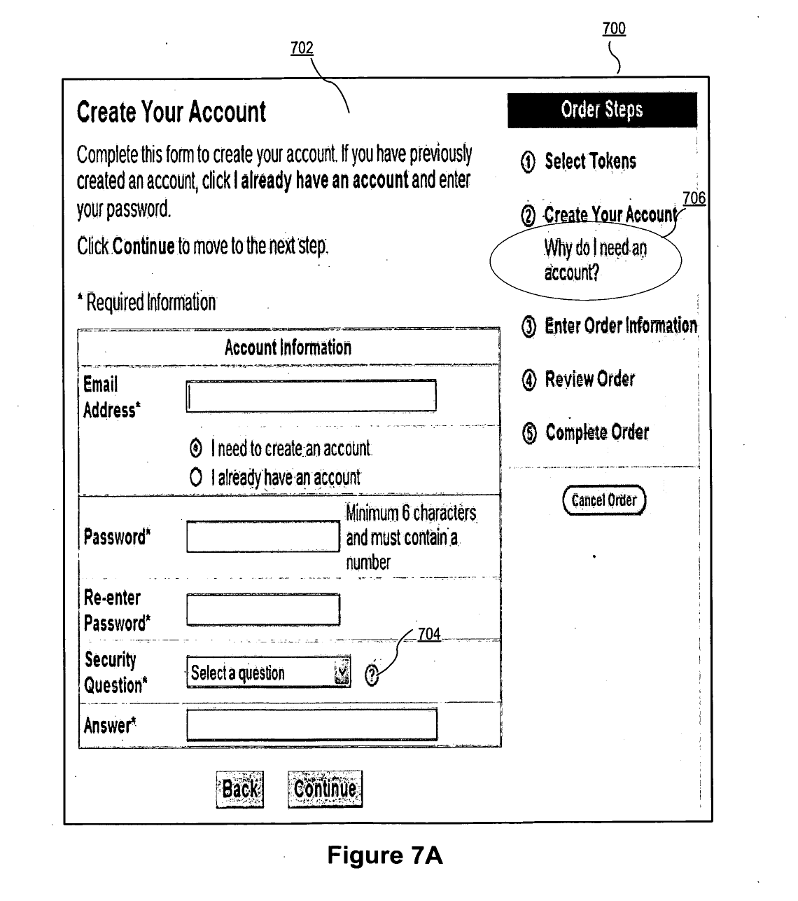

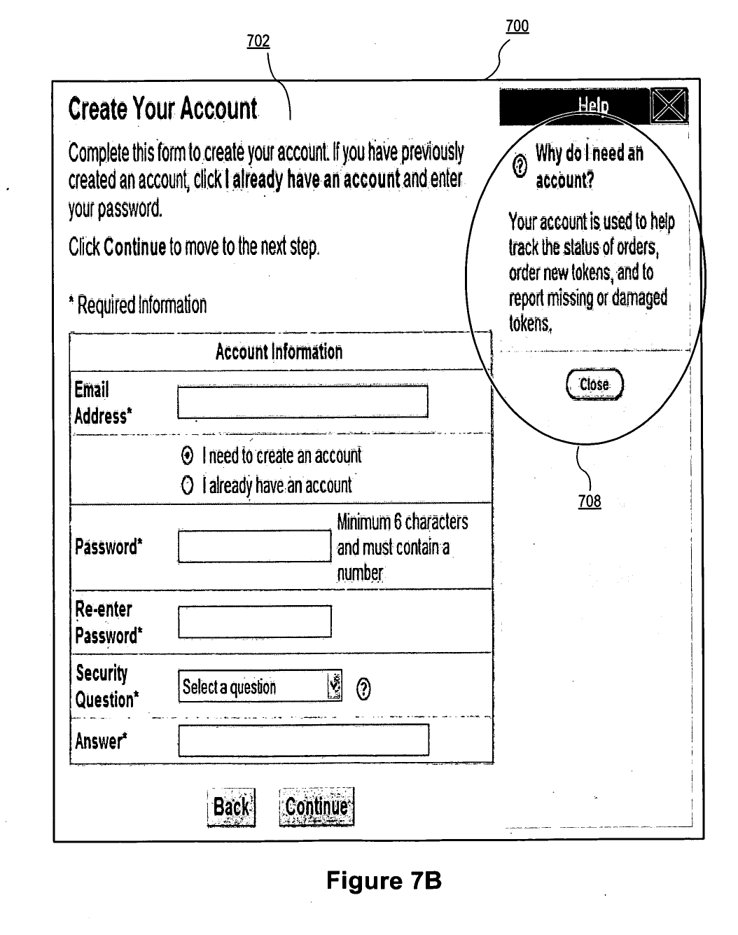

FIGS. 6-7 show exemplary representations of user interfaces facilitating support information display.

FIG. 6A illustrates a graphical user interface window 600 displaying an associated web page 602 and one or more help indicators 604 in a web page. Each of the help indicators 604 is individually selectable by a user.

FIG. 6B illustrates the graphical user interface window 600 and web page 602 of FIG. 6A displaying help information 606. In one embodiment, the help information is displayed in a region of the graphical user interface window 600 such that the help information is displayed concurrently with the main content 602 without either obscuring or interrupting the user's interaction with the web page, or workflow associated with the displayed web page. As can be seen, the dedicated area of FIG. 6A is blank, thereby ensuring that the help information 606 does not obscure any relevant data.

FIG. 6C illustrates the graphical user interface window 600 and web page 602 of FIG. 6B displaying help information. The graphical user interface window 600 further includes user selectable functions 610A and/or 610B to close the region of the graphical user interface window that is currently displaying help information, as well as a user selectable function 608 to cause the help system, as described above, to display additional help information. In one embodiment, help indicator 604 is configured to close the region of the graphical user interface window that is currently displaying help information when another selection of previously selected help indicator 604 is detected.

FIG. 6D illustrates the graphical user interface window 600 and web page 602 of subsequent to the closure of the help data region of the graphical user interface displayed in the web page.

FIG. 7A illustrates the graphical user interface window 700 and web page 702 displaying help indicator 704 and help indicator 706 in the web page. In one embodiment, a help indicator may be an icon, a link, some combination of both, etc.

FIG. 7B illustrates the graphical user interface window 700 and web page 702 of FIG. 7A displaying help information 708.

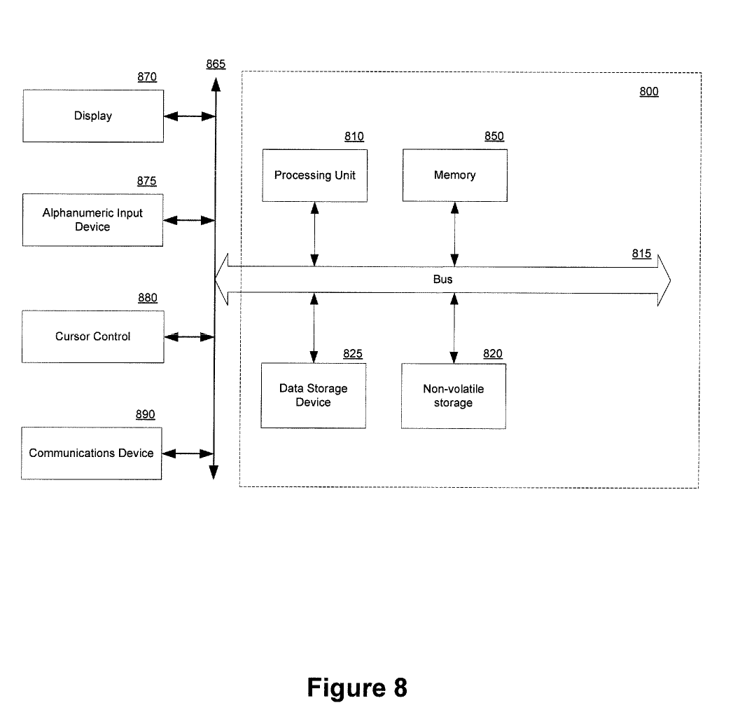

FIG. 8 is one embodiment of a computer system on which the present invention may be implemented. It will be apparent to those of ordinary skill in the art, however, that other alternative systems of various system architectures may also be used.

The data processing system illustrated in FIG. 8 includes a bus or other internal communication means 865 for communicating information, and a processor 860 coupled to the bus 865 for processing information. The system further comprises a random access memory (RAM) or other volatile storage device 850 (referred to as memory), coupled to bus 865 for storing information and instructions to be executed by processor 860. Main memory 850 also may be used for storing temporary variables or other intermediate information during execution of instructions by processor 860. The system also comprises a read only memory (ROM) and/or static storage device 820 coupled to bus 865 for storing static information and instructions for processor 660, and a data storage device 825 such as a magnetic disk or optical disk and its corresponding disk drive. Data storage device 825 is coupled to bus 865 for storing information and instructions.

The system may further be coupled to a display device 870, such as a cathode ray tube (CRT) or a liquid crystal display (LCD) coupled to bus 865 through bus 865 for displaying information to a computer user. An alphanumeric input device 875, including alphanumeric and other keys, may also be coupled to bus 865 through bus 865 for communicating information and command selections to processor 860. An additional user input device is cursor control device 880, such as a mouse, a trackball, stylus, or cursor direction keys coupled to bus 865 through bus 865 for communicating direction information and command selections to processor 860, and for controlling cursor movement on display device 870.

Another device, which may optionally be coupled to computer system 800, is a communication device 890 for accessing other nodes of a distributed system via a network. The communication device 890 may include any of a number of commercially available networking peripheral devices such as those used for coupling to an Ethernet, token ring, Internet, or wide area network. The communication device 890 may further be a null-modem connection, or any other mechanism that provides connectivity between the computer system 800 and the outside world. Note that any or all of the components of this system illustrated in FIG. 8 and associated hardware may be used in various embodiments of the present invention.

It will be appreciated by those of ordinary skill in the art that any configuration of the system may be used for various purposes according to the particular implementation. The control logic or software implementing the present invention can be stored in main memory 850, mass storage device 825, or other storage medium locally or remotely accessible to processor 860.

It will be apparent to those of ordinary skill in the art that the system, method, and process described herein can be implemented as software stored in main memory 850 or read only memory 820 and executed by processor 860. This control logic or software may also be resident on an article of manufacture comprising a computer readable medium having computer readable program code embodied therein and being readable by the mass storage device 825 and for causing the processor 860 to operate in accordance with the methods and teachings herein.

The present invention may also be embodied in a handheld or portable device containing a subset of the computer hardware components described above. For example, the handheld device may be configured to contain only the bus 865, the processor 860, and memory 850 and/or 825. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 860, a data storage device 825, a bus 865, and memory 850, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 860. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. carrier waves, infrared signals, digital signals, etc.).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
providing a web page over a network, a window displaying the web page including a help indicator;
receiving a selection of the help indicator;
providing a response, including support information based on a current context of the web page, for display in an area in the window without obscuring or disrupting content displayed in the web page.

2. The method of claim 1, wherein the response is pre-generated and provided with the web page, and the selection does not require communication with a server.

3. The method of claim 1, further comprising:
receiving another user selection of the previously selected help indicator; and
removing the support information displayed from the window.

4. The method of claim 1, further comprising:
determining whether the support information remains relevant based on an updated context; and
removing the support information when the updated context indicates that the support information is no longer relevant.

5. The method of claim 1, further comprising:
receiving a request, subsequent to the response, for additional support information; and
providing a response based on the support information included in the response and the current context of the web page.

6. The method of claim 1, wherein the response is displayed over a dedicated help pane of the web page displayed in the window of the graphical user interface.

7. The method of claim 6, wherein the dedicated help pane is placed at a location in the window that will minimize distraction to a user when help information is displayed in the help pane along with the web page.

8. The method of claim 1, wherein providing a response further comprises:
dynamically generating one or more queries to a database based on the current context of the web page, wherein the database stores multimedia support information;
generating a response based on the results of the one or more queries to the database.

9. The method of claim 1, wherein the web page is a web enabled application.

10. An apparatus comprising:
a support request logic to receive a selection of a help indicator; and
a support request generation logic to compose a support request based on a current context of a web page.

11. The apparatus of claim 10, wherein the support request generation logic further comprises:
a context acquisition logic to analyze the current context of the web page;
a data receipt logic to gather and analyze user data associated with the current context; and
the support request generation logic to combine analysis results of the context acquisition logic and the data receipt logic to generate the support request.

12. The apparatus of claim 11, further comprising:
a support request delivery logic to transmit the support request to a support response logic over a network.

13. The apparatus of claim 10, further comprising:
a graphical user interface and data receipt logic to receive a response to the support request, and configure the response for display in an area of the web page without obscuring or disrupting content already displayed in the web page.

14. The apparatus of claim 13, further comprising:
the support request generation logic to transmit an updated context based on a new context of the web page to determine whether support information remains relevant based on the updated context; and
the graphical user interface and data receipt logic to remove the support information when a response to the updated context indicates that the support information is no longer relevant.

15. An apparatus comprising:
a support response logic to receive a support request over a network, the support request including a current context of a web page associated with the support request; and
a response delivery logic to transmit a response over the network, including support information based on the current context of the web page.

16. The apparatus of claim 15, wherein the support request response logic further comprises:
a context analysis logic to dynamically generate one or more queries to a database based on the current context of the web page, wherein the database stores support information.

17. The apparatus of claim 16, wherein the response is generated based on the results of the one or more queries to the database.

18. The apparatus of claim 17, wherein the database comprises a multimedia database including text, video, and audio help files.

19. The apparatus of claim 15, further comprising:
the support response logic to receive an updated context for the web page over the network; and
the response delivery logic to transmit a response over the network to remove support information when the updated context indicates that the support information is no longer relevant.
